(19) United States
(12) Patent Application Publication
(10) Pub. No.: US 2016/0142704 A1
(43) Pub. Date: May 19, 2016

(54) STEREOSCOPIC IMAGE DISPLAY DEVICE

(71) Applicant: SAMSUNG DISPLAY CO., LTD., YONGIN-CITY (KR)

(72) Inventors: GORO HAMAGISHI, HWASEONG-SI (KR); SE HUHN HUR, YONGIN-SI (KR); IL-JOO KIM, HWASEONG-SI (KR); SEUNG JUN JEONG, HWASEONG-SI (KR)

(21) Appl. No.: 14/819,073

(22) Filed: Aug. 5, 2015

(30) Foreign Application Priority Data
Nov. 14, 2014 (KR) 10-2014-0158974

(51) Int. Cl. H04N 13/04

(52) U.S. Cl. CPC H04N 13/0484; H04N 13/0404

(57) ABSTRACT

A stereoscopic image display device includes: a display panel that includes a plurality of pixels arranged in a matrix form; and a viewpoint separating unit for dividing an image displayed by the display panel into images corresponding to k viewpoints. The viewpoint separating unit includes a plurality of viewpoint separating units that are tilted at a tilt angle VA with respect to a column direction of the pixels that satisfies the following equation.

$$VA = {tan}^{- 1} \frac{b \times Hp}{m \times Vp} ,$$

Herein, Hp denotes a pitch in a row direction of the pixels, Vp denotes a pitch in the column direction of the pixels, and m and b are natural numbers, and a width of a display panel area viewed at an optimal viewing distance (OVD) by each of the viewpoint separating units satisfies

$$\frac{2 n}{m} \times Hp ,$$

where n is a natural number.

### CROSS-REFERENCE TO RELATED APPLICATION

This application claims priority from Korean Patent Application No. 10-2014-0158974, filed in the Korean Intellectual Property Office on Nov. 14, 2014, and all the benefits accruing therefrom, the contents of which are herein incorporated by reference in their entirety.

### BACKGROUND

(a) Technical Field

Embodiments of the present disclosure are directed to a stereoscopic image display device, and more particularly, to an autostereoscopic image display device.

(b) Discussion of the Related Art

Advancements in display device technologies have included advances in multi-view image display devices and stereoscopic image display devices.

In general, for a multi-view image display device, different viewing areas, hereinafter referred to as “viewing zones”, are created based on viewing angles.

A multi-view image display device displays an image such that viewers located at different viewing zones view different images.

By applying a multi-view image display device for displaying different images in the different viewing zones, a stereoscopic image display device can display objects in 3D using binocular parallax.

A stereoscopic image display device displays an image such that different two-dimensional (2D) images are respectively viewed in a viewing zone of viewer's left eye and a viewing zone of a viewer's right eye.

Then, an image viewed by the left eye, hereinafter referred to as a “left eye image”, and an image viewed by the right eye, hereinafter referred to as a “right eye image”, are transmitted to a viewer's brain, such that the left and right eye images are perceived as a 3D stereoscopic image having depth.

Multi-view image display devices or stereoscopic image display devices may be classified as a stereoscopic type that uses glasses, such as shutter glasses, polarized glasses, etc., and an autostereoscopic type which uses an optical system such as a lenticular lens, a parallax barrier, etc., in a display device instead of glasses.

An autostereoscopic type divides a stereoscopic image into images with multiple viewpoints and then displays them using a lenticular lens, a parallax barrier having a plurality of apertures, etc., to implement a multiple viewpoint image or stereoscopic image.

### SUMMARY

Embodiments of the present disclosure can provide a stereoscopic image display device and a display method thereof that can optimize a resolution of a stereoscopic image viewed at each of viewpoints in an autostereoscopic image display device.

In addition, embodiments of the present disclosure can provide a stereoscopic image display device and a display method thereof that can prevent crosstalk and color break from occurring in an autostereoscopic image display device.

According to an embodiment of the present disclosure, a stereoscopic image display device includes: a display panel that includes a plurality of pixels arranged in a matrix form; and a viewpoint separating unit for dividing an image displayed by the display panel into images corresponding to k viewpoints. The viewpoint separating unit includes a plurality of viewpoint separating units that are tilted in a tilt angle VA with respect to a column direction of the pixels that satisfies the following equation:

$$VA = {tan}^{- 1} \frac{b \times Hp}{m \times Vp} ,$$

wherein Hp denotes a pitch in a row direction of the pixels, Vp denotes a pitch in the column direction of the pixels, and m and b are natural numbers, and a width of a display panel area viewed at an optimal viewing distance (OVD) by each of the viewpoint separating units satisfies

$$\frac{2 n}{m} \times Hp ,$$

wherein n is a natural number.

The viewpoint separating units may include a parallax barrier.

$$\frac{2 n}{m}$$

may be less than 1.

The plurality of pixels may emit light that corresponds to different viewpoint images in the row direction for every pixel.

When b is 1, the plurality of pixels may emit light that corresponds to different viewpoint images in the column direction for every m pixels.

m may be less than 4.

The viewpoint separating unit may include a plurality of apertures and a plurality of light blocking portions, and satisfies the following equation:

Hp:g=E:d

d:Bp=(d+g):2Hp

wherein d denotes the OVD, Bp denotes an interval between the plurality of apertures, E denotes an interval between both eyes of a viewer, and g denotes a distance between the viewpoint separating unit and the display panel.

An aperture width of the parallax barrier may satisfy the following equation:

W:d=X:(d+g),

wherein X denotes the width of the display panel area viewed at the OVD by each of the viewpoint separating units and W denotes an aperture width.

The stereoscopic image display device may further include a sensor for detecting positions of both eyes of a viewer, and a controller for performing head-tracking to change which pixels are displayed in images corresponding to the k viewpoints.

The controller may set observing areas having a width of E/m at the OVD as head tracking control units, and may perform head-tracking.

The controller may set a boundary of the head tracking control units as a boundary for head-tracking control if m is an odd number.

The controller may set a center of the head tracking control units as a boundary for head-tracking control if m is an even number.

According to another embodiment of the present disclosure, a stereoscopic image display device includes: a display panel that includes a plurality of pixels arranged in a matrix form; and a viewpoint separating unit for dividing an image displayed by the display panel into images corresponding to k viewpoints. The viewpoint separating unit includes a plurality of viewpoint separating units that include a parallax barrier, and the viewpoint separating unit includes a plurality of apertures and a plurality of light blocking portions, and satisfies the following equations:

Hp:g=E:d

d:Bp=(d+g):2Hp

where d denotes the OVD, Bp denotes an interval between the apertures, E denotes an interval between both eyes of a viewer, and g denotes a distance between the viewpoint separating unit and the display panel.

The viewpoint separating units may be tilted at a tilt angle VA with respect to a column direction of the pixels that satisfies the following equation:

$$VA = {tan}^{- 1} \frac{b \times Hp}{m \times Vp} ,$$

where Hp denotes a pitch in a row direction of the pixels, Vp denotes a pitch in the column direction of the pixels, and m and b are natural numbers, and a width of a display panel area viewed at an optimal viewing distance (OVD) by each of the viewpoint separating units satisfies

$$\frac{2 n}{m} \times Hp ,$$

wherein n is a natural number.

The stereoscopic image display device may further include: a sensor for detecting positions of both eyes of a viewer; and a controller for performing head-tracking to change which pixels are displayed in images corresponding to the k viewpoints. The controller may set observing areas having a width of E/m at the OVD as head tracking control units, and performs head-tracking.

The stereoscopic image display device may satisfy the following equation: W:d=X:(d+g), wherein X denotes the width of the display panel area viewed at the OVD through each of the viewpoint separating units and W denotes an aperture width.

According to another embodiment of the present disclosure, a stereoscopic image display device includes: a display panel that includes a plurality of pixels arranged in a matrix form; a viewpoint separating unit for dividing an image displayed by the display panel into images corresponding to k viewpoints, where the viewpoint separating unit includes a plurality of viewpoint separating units, a sensor for detecting positions of both eyes of a viewer, and a controller for performing head-tracking to change which pixels are displayed in images corresponding to the k viewpoints. The controller sets observing areas having a width of E/m at an optimal viewing distance (OVD) as head tracking control units, and performs head-tracking, where E denotes an interval between both eyes of a viewer, and m is a natural number that is a coefficient of a vertical pitch of the pixels.

The viewpoint separating units may include a parallax barrier, and may include a plurality of apertures and a plurality of light blocking portions, and may satisfy the following equations:

Hp:g=E:d

d:Bp=(d+g):2Hp

W:d=X:(d+g),

where d denotes the OVD, Bp denotes an interval between the apertures, E denotes an interval between both eyes of a viewer, g denotes a distance between the viewpoint separating unit and the display panel, X denotes the width of the display panel area viewed at the OVD through each of the viewpoint separating units and W denotes an aperture width.

The viewpoint separating units may be tilted at a tilt angle VA with respect to a column direction of the pixels that satisfies the following equation:

$$VA = {tan}^{- 1} \frac{b \times Hp}{m \times Vp} ,$$

where Hp denotes a pitch in a row direction of the pixels, Vp denotes a pitch in the column direction of the pixels, and m and b are natural numbers, and a width of a display panel area viewed at an optimal viewing distance (OVD) by each of the viewpoint separating units satisfies

$$\frac{2 n}{m} \times Hp ,$$

wherein n is a natural number.

According to exemplary embodiments of the present disclosure, a resolution of a stereoscopic image displayed in an autostereoscopic image display device can be optimized.

In addition, according to exemplary embodiments of the present disclosure, crosstalk and color break can be substantially prevented from occurring in an autostereoscopic image display device.

However, since various modifications and alterations within the spirit and scope of the present disclosure may be clearly understood by those skilled in the art, it is to be understood that a detailed description and a specific exemplary embodiment of the present disclosure such as an exemplary embodiment of the present disclosure are provided only by way of example.

### BRIEF DESCRIPTION OF THE DRAWINGS

FIG. 1 is a schematic perspective view of a stereoscopic image display device according to an exemplary embodiment.

FIG. 2 illustrates a viewpoint separating unit of a stereoscopic image display device according to an exemplary embodiment and light of pixels passing through an optimal viewing distance (OVD) through the viewpoint separating unit.

FIGS. 3 and 4 illustrate a layout of a display panel of a stereoscopic image display device according to an exemplary embodiment.

FIGS. 5 to 9 illustrate pixels corresponding to aperture widths of a parallax barrier and tilt angles of the parallax barrier in connection with moiré patterns and color breakup of a stereoscopic image display device according to various exemplary embodiments.

FIG. 10 illustrates images displayed in pixels corresponding to an aperture width and a tilt angle of a parallax barrier of a stereoscopic image display device according to an exemplary embodiment.

FIG. 11 illustrates when light of the pixels of a stereoscopic image display device according to an exemplary embodiment crosses the OVD after passing through the parallax barrier.

FIG. 12 illustrates an aperture width of a parallax barrier of a stereoscopic image display device according to an exemplary embodiment.

FIG. 13 illustrates an area viewed by a viewer at the OVD through a stereoscopic image display device according to an exemplary embodiment.

FIGS. 14 to 17 illustrate an example of head-tracking for changing the pixels that emit light corresponding to a binocular image of a stereoscopic image display device according to an exemplary embodiment.

FIG. 18 illustrates a head-tracking boundary for changing pixels that emit light for a binocular image of a stereoscopic image display device according to another exemplary embodiment.

FIG. 19 illustrates pixels that correspond to a parallax barrier aperture and tilt angle in connection with moiré patterns and color breakup of a stereoscopic image display device according to a further exemplary embodiment.

FIGS. 20(A)-(B) and 21(A)-(B) illustrate head-tracking for changing pixels that emit light for a binocular image of a stereoscopic image display device according to a further exemplary embodiment.

FIGS. 22 and 23 illustrate crosstalk caused by head-tracking of a stereoscopic image display device according to the exemplary embodiment.

FIGS. 24 and 25 illustrate crosstalk caused by head-tracking of a stereoscopic image display device according to another exemplary embodiment.

FIGS. 26 to 35 illustrate tilt angles of a parallax barrier according to a stereoscopic image display device according to various exemplary embodiments and pixels that emit light for the images displayed according to the tilt angles.

FIGS. 36 and 37 illustrate head-tracking for changing pixels that emit light for a binocular image of a stereoscopic image display device according to an exemplary embodiment of FIG. 31.

### DETAILED DESCRIPTION OF THE EMBODIMENTS

Hereinafter, exemplary embodiments of the present disclosure will be described in detail with reference to the accompanying drawings. In the present disclosure, the same or similar components may be denoted by the same or similar reference numerals, and an overlapping description thereof will be omitted.

In addition, the accompanying drawings are provided only to allow exemplary embodiments disclosed in the present disclosure to be easily understood and thus are not to be interpreted as limiting the spirit disclosed in the present disclosure, and it is to be understood that the present disclosure includes all modifications, equivalents, and substitutions without departing from the scope and spirit of the present disclosure.

It is to be understood that when one component is referred to as being “connected” or “coupled” to another component, it may be connected or coupled directly to another component or be connected or coupled to another component with the other component intervening therebetween.

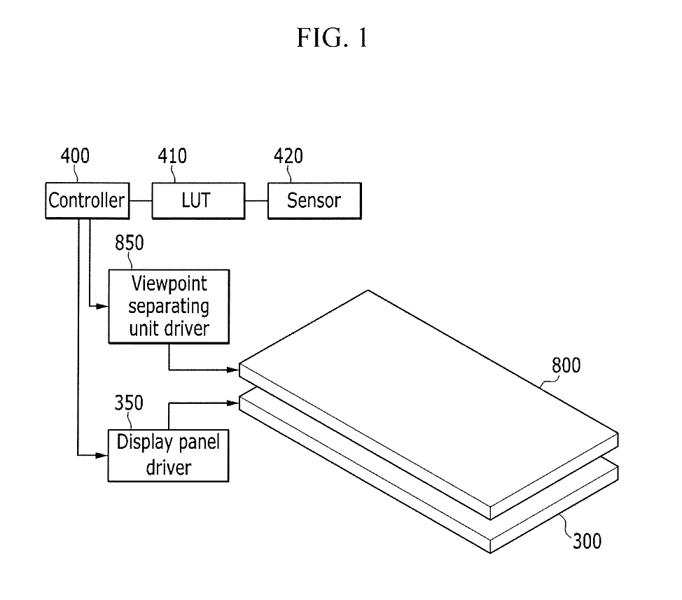

FIG. 1 is a schematic perspective view of a stereoscopic image display device according to an exemplary embodiment.

A stereoscopic image display device according to an exemplary embodiment includes a display panel 300, a display panel driver 350, a viewpoint separating unit 800, a viewpoint separating unit driver 850, a controller 400, a lookup table (LUT) 410, and a sensor 420.

The display panel 300 displays an image, and may be one of various display panels, such as a plasma display panel (PDP), a liquid crystal display (LCD), an organic light emitting diode (OLED) display, etc.

The display panel 300 includes a plurality of signal lines and a plurality of pixels coupled thereto.

The plurality of pixels may be arranged in an approximate matrix form.

Each pixel may include switching elements, such as thin film transistors, etc. connected to the signal lines, and a pixel electrode coupled thereto.

The signal lines may include a plurality of gate lines that transmit gate signals to the corresponding pixels, referred to as “scanning signals” or “scan signals”, and a plurality of data lines that transmitting data signals to the corresponding pixels.

A pixel PX may uniquely displays one primary color in a spatial division mode, or a pixel may alternately display each primary color over time in a temporal division mode, thereby displaying a desired color on the display panel 300 by a spatial or temporal sum of the primary colors.

The primary colors may be various combinations of three primary colors or four primary colors, but a non-limiting selection of red (R), green (G), and blue (B) are described in an exemplary embodiment of the present disclosure.

A set of pixels PX that display different primary colors may together constitute one dot, and as a display unit of the stereoscopic image, one dot may display white.

One pixel may instead be referred to as one dot.

Hereinafter, when there is no specific limitation, one dot represents one pixel.

The pixels of one pixel column may display the same primary color but are not limited thereto, and the pixels in a diagonal line at a predetermined angle may display the same primary color.

The display panel driver 350 transmits various driving signals, such as the gate signals and the data signals, to the display panel 300 to drive the display panel 300.

The viewpoint separating unit 800 may pass, transmit, refract, reflect, or split light of the pixels of the display panel 300.

The viewpoint separating unit driver 850 is connected to the viewpoint separating unit 800 to generate a driving signal that can drive the viewpoint separating unit 800.

For example, the viewpoint separating unit driver 850 may generate a driving signal that can stop operation of the viewpoint separating unit 800 when the stereoscopic image display device displays a planar image.

Alternatively, the viewpoint separating unit driver 850 may generate a driving signal that can initiate operation of the viewpoint separating unit 800 when the stereoscopic image display device displays a stereoscopic image.

The sensor 420 is an eye tracking sensor that can detect a location of and a distance from a viewer's eyes.

The sensor 420 can detect where centers of a viewer's eyes' pupils are located and the distance from a stereoscopic image display device to the viewer's eyes.

In addition, the sensor 420 may detect a distance between the viewer's eyes' two pupils.

The distance between the viewer's eyes' two pupils may be a distance between the centers of the viewer's eyes' two pupils.

Sensing data detected by the sensor 420 is transmitted to the LUT 410.

The LUT 410 can store operation timing data corresponding to the sensing data.

The operation timing data is appropriately selected based on the sensing data that is received from the sensor 420.

The selected operation timing data is transmitted to the controller 400.

The controller 400 can control the display panel driver 350 and the viewpoint separating unit driver 850 such that a left eye image and a right eye image are respectively projected to the viewer's two eyes based on the operation timing data of the sensing data of the sensor 420.

That is, the controller 400 can perform a head-tracking function.

The viewpoint separating unit 800 may be disposed at a rear side of the display panel 300, or a plurality of viewpoint separating units 800 may be disposed between the display panel 300 and the viewer.

The viewpoint separating unit driver 850 is connected to the viewpoint separating unit 800 to generate the driving signals that can drive the viewpoint separating unit 800.

For example, the viewpoint separating unit driver 850 may generate a driving signal to halt operation of the viewpoint separating unit 800 when the multi-view image display device displays one image on the entire display panel 300.

Alternatively, the viewpoint separating unit driver 850 may generate a driving signal to initiate operation of the viewpoint separating unit 800 when the multi-view image display device displays multi-view images.

FIG. 1 illustrates an exemplary embodiment in which the display panel driver 350 and the viewpoint separating unit driver 850 are separately provided and in which the controller 400 controls the display panel driver 350 and the viewpoint separating unit driver 850, but the display panel driver 350, the viewpoint separating unit driver 850 may be integrated as a single driver, or display panel driver 350, the viewpoint separating unit driver 850, and the controller 400 may integrated into one unit. In addition, the LUT 410 may be incorporated into the controller 400.

Through a multi-view image display device, a viewer may perceive light passing through the same viewpoint as one image, and a plurality of images may be perceived at the respective viewpoints.

When a multi-view image display device is operated as a stereoscopic image display device, a viewer may perceive different images from light emitted from pixels corresponding to different viewpoint with their respective eyes, thereby experiencing depth, that is, a sense of visual depth.

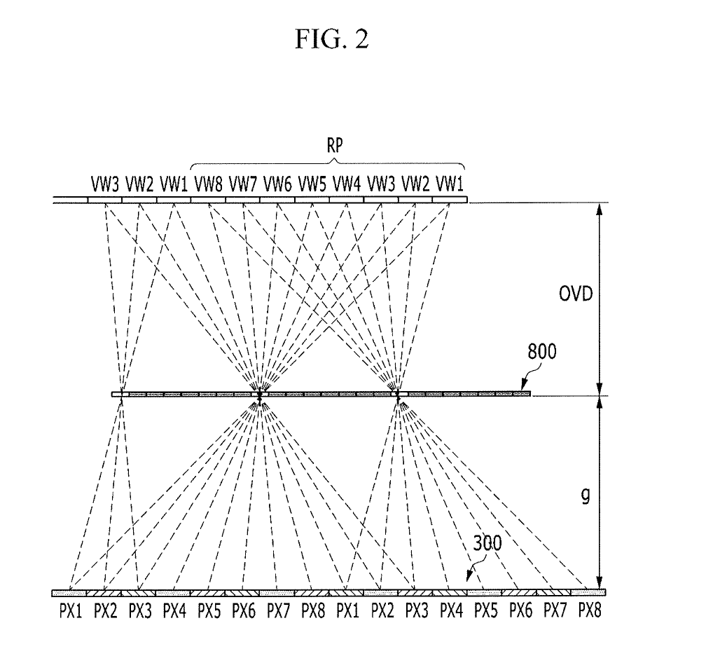

Referring to FIG. 2, the viewpoint separating unit 800 according to an exemplary embodiment may include a parallax barrier that includes a plurality of apertures and a plurality of light blocking portions.

Alternatively, the viewpoint separating unit 800 may include a plurality of lenticular lenses arranged in one direction.

The viewpoint separating unit 800 will now be described in term of a parallax barrier.

A plurality of apertures and a plurality of light blocking portions may be formed in the parallax barrier 800.

The apertures and the light blocking portions of the parallax barrier 800 may extend in one direction.

An extension direction of each of the apertures and each of the light blocking portions may be tilted to form an acute angle with respect to a column direction of the pixels.

Alternatively, the extension direction of each of the apertures and each of the light blocking portions may be substantially parallel with the column direction of the pixels.

Letting a distance from the stereoscopic image display device to a location where an optimal stereoscopic image can be viewed be referred to as an optimal viewing distance (OVD), the light emitted from each pixel PX1 to PX8 may pass through apertures of the parallax barrier 800 and locations at the OVD that are referred to as viewpoints.

FIG. 2 illustrates a finite number of viewpoints VW1 to VW8 that are positioned at the OVD.

According to an exemplary embodiment, each of the pixels PX1 to PX8 of the display panel 300 corresponds to any one of the plurality of viewpoints VW1 to VW8, and light from each of the pixels PX1 to PX8 propagates through the apertures of the parallax barrier 800, thereby passing through the corresponding viewpoints VW1 to VW8.

Each of the viewpoints VW1 to VW8 is located in a unit view area RP.

In addition, the unit view area RP may be periodically repeated at the OVD, and each unit view area RP includes a same sequence of the viewpoints VW1 to VW8.

For example, letting the pixels corresponding to the first viewpoint be referred to as PX1, light of the first pixels PX1 propagates through the apertures of the parallax barrier 800 of the viewpoint separating unit 800, thereby passing through the first viewpoint VW1 in any one of the unit view areas RP.

As described above, light of the first pixels PX1 propagates through one or more apertures, and may pass through a plurality of first viewpoints VW1 that are present at the OVD.

If a viewer's eye is located at the first viewpoints VW1, the viewer's eye may receive light of the first pixel PX1, and may perceive an image corresponding to the first viewpoint through the received light.

For this purpose, various conditions may be appropriately adjusted, such as a width of the lenticular lenses 810 or the apertures 820, an arrangement direction of the apertures 820 or an extension direction of the lenses, the OVD, or a distance g1 between the display panel 300 and the viewpoint separating unit 800, etc.

When the viewpoint separating unit 800 includes a parallax barrier, the width of each of the apertures 820 may be about one-eighth of a pitch P of the apertures 820, but it is not limited thereto.

In FIGS. 1 and 2, one viewpoint separating unit 800 is illustrated as being disposed between the display panel 300 and the viewer, but embodiments of the present disclosure are not limited thereto.

The viewpoint separating unit 800 may be disposed at a rear side of the display panel 300, or a plurality of viewpoint separating units 800 may be disposed between the display panel 300 and the viewer.

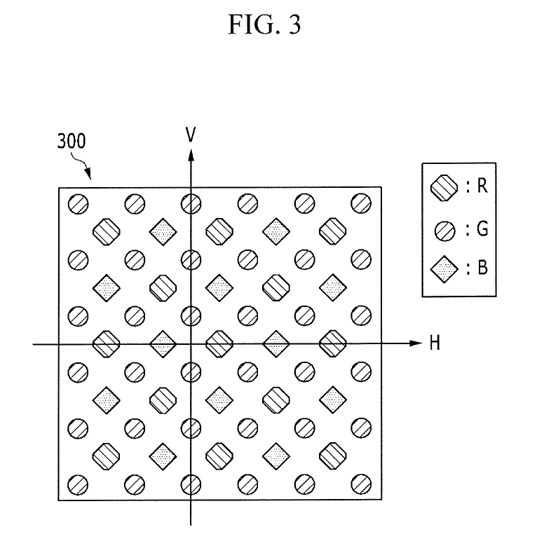

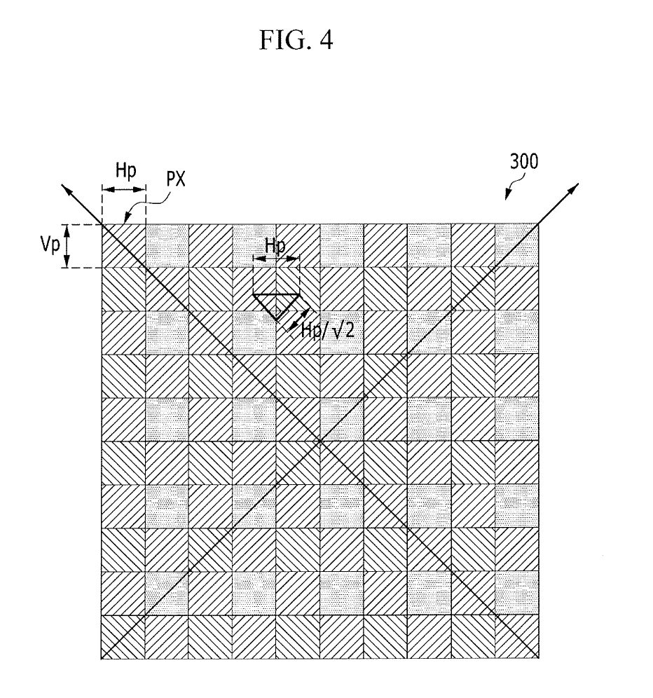

FIGS. 3 and 4 illustrate a layout of a display panel of a stereoscopic image display device according to an exemplary embodiment.

As shown in FIG. 3, green pixels may be arranged in a matrix form on the display panel.

In addition, red pixels and blue pixels may be alternately arranged in a matrix form on the display panel.

FIG. 4 illustrates a pixel arrangement when the display panel illustrated in FIG. 3 is rotated, and as shown in FIG. 4, the pixels PX may have respective predetermined horizontal and vertical pitches Hp and Vp on the display panel.

A parallax barrier that can prevent moiré patterns and color breakup when the pixels are arranged as shown in FIG. 4 will now be described.

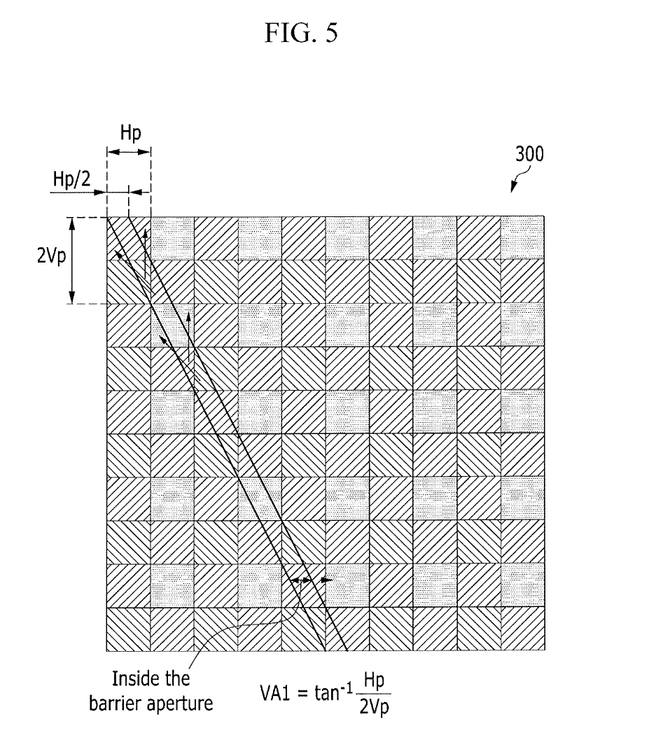

FIGS. 5 to 9 illustrate pixels corresponding to aperture widths of a parallax barrier and tilt angles of the parallax barrier in connection with moiré patterns and color breakup of a stereoscopic image display device according to various exemplary embodiments.

Tilt angles of the parallax barriers of FIGS. 5 to 9 may satisfy the following Equation 1, where m and b are natural numbers.

$$VA = {tan}^{- 1} \frac{b \times Hp}{m \times Vp} \qquad ( Equation 1 )$$

In the parallax barrier tilt angles of the exemplary embodiments of FIGS. 5 to 7, b is 1 and m is 2.

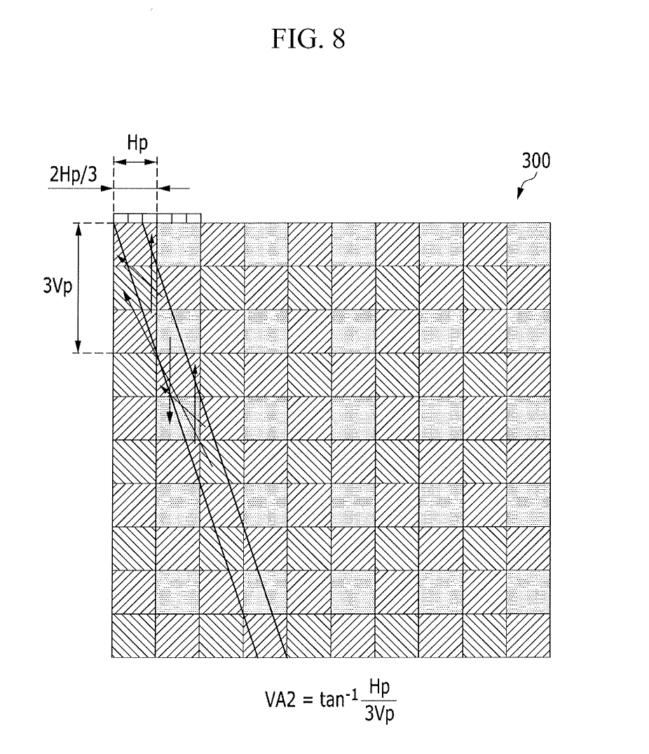

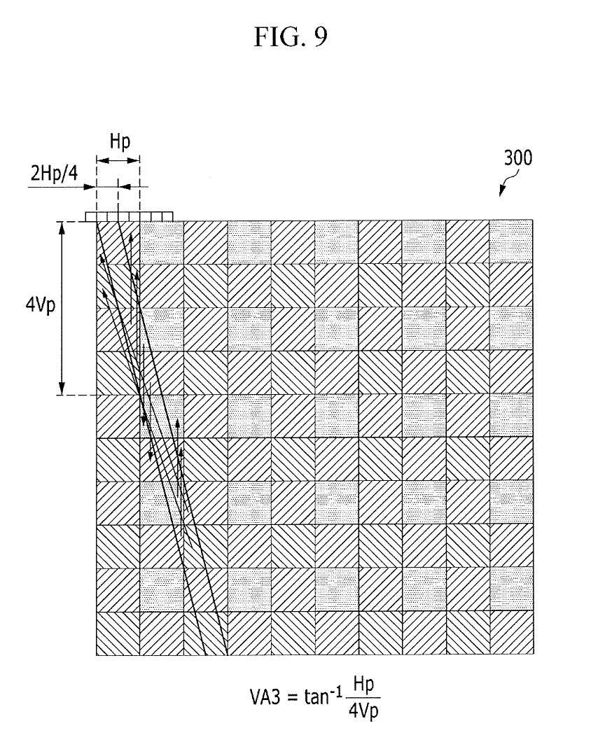

In addition, in the parallax barrier tilt angles of exemplary embodiment of FIG. 8, b is 1 and m is 3, and in the parallax barrier tilt angles of the exemplary embodiment of FIG. 9, b is 1 and m is 4.

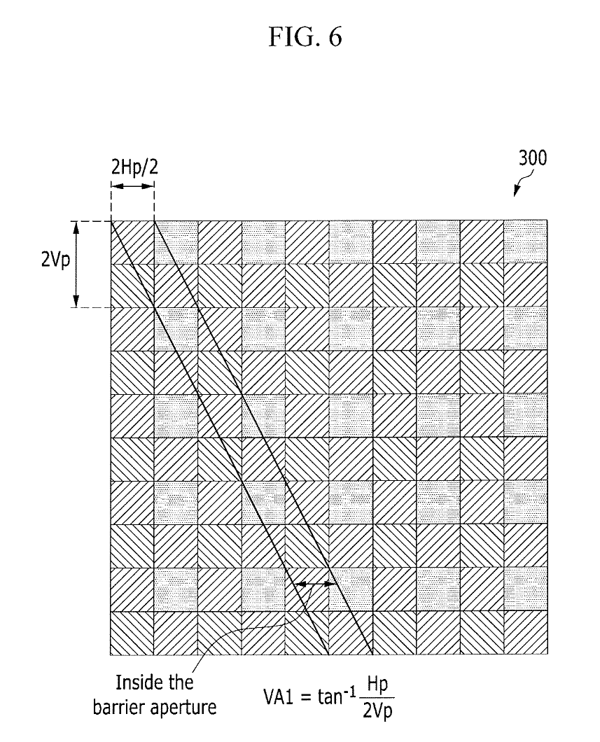

As shown in FIGS. 5 and 6, a tilt angle VA1 of a parallax barrier disposed at an upper part of a display panel may satisfy the following Equation 2.

$$VA 1 = {tan}^{- 1} \frac{Hp}{2 Vp} \qquad ( Equation 2 )$$

That is, the tilt angle VA1 may cover two vertical pitches Vp and one horizontal pitch Hp such that it covers two column pixels and one row pixel.

When the parallax barrier satisfies Equation 1, the aperture width of the parallax barrier may relate to a coefficient of the vertical pitch Vp of Equation 1 to reduce the moiré effect.

For example, as shown in FIG. 5, a width of an area corresponding to an aperture width of the parallax barrier may be ½ the horizontal pitch Hp of the pixels.

In this case, ½ is a reciprocal of the coefficient of the vertical pitch Vp of Equation 1.

Then, through two rows of pixels within the parallax barrier aperture, an area substantially equal to that of one pixel may be viewed.

Through four rows of pixels within the parallax barrier aperture, an area substantially equal to that of two pixels may be viewed.

That is, through the four rows of pixels within the parallax barrier aperture, one green pixel, half a red pixel, and half a blue pixel may be viewed.

Accordingly, even if a viewing position changes, luminance does not change due to the changed viewer position since the area viewed through the four rows of pixels within the parallax barrier aperture is always substantially equal to that of the two pixels, thereby preventing the moiré effect.

In addition, through the aperture, center portions of the green and blue pixels are viewed and peripheral portions of the red pixels are viewed.

Emission areas are located at the center portions of the pixels, while black matrices are disposed in the peripheral portions of the pixels.

The green and blue pixels, of which the emission areas are primarily viewed, appear relatively brighter than the red pixels, of which the black matrices are primarily viewed, thereby causing color breakup.

Accordingly, to reduce color breakup, the width of the parallax barrier aperture may be widened, as shown in FIG. 6, to be 2*½ the horizontal pitch Hp of the pixel.

Then, through four rows of pixels within the parallax barrier aperture, an area substantially equal to that of four pixels may be viewed.

That is, through the four rows of pixels within the parallax barrier aperture, two green pixels, one red pixel, and one blue pixel may be viewed.

In this case, since center portions of each of the green pixels, red pixels, and blue pixels can be viewed through the aperture, color breakup can be prevented.

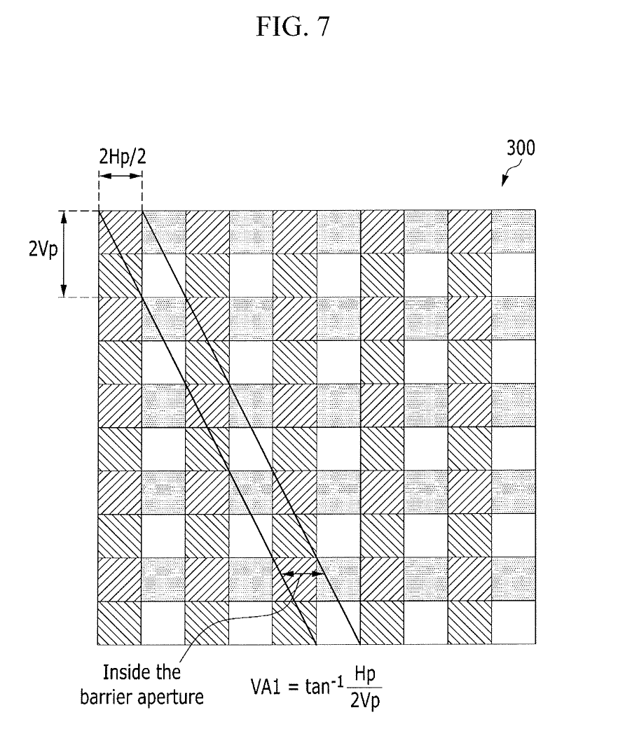

In FIG. 7, the tilt angle of the parallax barrier is equal to that of the exemplary embodiment illustrated in FIG. 5.

On the display panel of FIG. 7, alternate green pixels in a diagonal direction may be changed to a white pixel such that green pixels and white pixels are alternately disposed in the diagonal direction.

When a width of the parallax barrier aperture is 2*½ times the horizontal pitch Hp of the pixels, an area substantially equal to that of four pixels may be viewed through four rows of pixels within the parallax barrier aperture.

That is, through the four rows of pixels within the parallax barrier aperture, one green pixel, one white pixel, one red pixel, and one blue pixel may be viewed.

In this case, since center portions of each of the green pixels, white pixels, red pixels, and blue pixels can be viewed through the aperture, color breakup can be prevented.

Next, as shown in FIG. 8, a tilt angle VA2 of a parallax barrier disposed at the upper part of a display panel may satisfy the following Equation 3.

$$VA 2 = {tan}^{- 1} \frac{Hp}{3 Vp} \qquad ( Equation 3 )$$

That is, the tilt angle VA2 may cover three vertical pitches Vp and one horizontal pitch Hp such that it covers three column pixels and one row pixel.

A width of an aperture of the parallax barrier may be multiples of ⅓ times the horizontal pitch Hp of the pixels.

In this case, ⅓ is a reciprocal of a coefficient of the vertical pitch Vp of Equation 3.

To reduce moiré patterns and color breakup, the width of the aperture of the parallax barrier may 2*⅓ times the horizontal pitch Hp of the pixels.

Then, through six rows of pixels within the parallax barrier aperture, an area substantially equal to that of four pixels may be viewed.

That is, through the six rows of pixels within the parallax barrier aperture, two green pixels, one red pixel, and one blue pixel may be viewed.

In this case, since center portions of each of the green pixels, red pixels, and blue pixels can be viewed through the aperture, color breakup can be prevented.

Next, as shown in FIG. 9, a tilt angle VA3 of a parallax barrier disposed at the upper part of a display panel may satisfy Equation 4.

$$VA 3 = {tan}^{- 1} \frac{Hp}{4 Vp} \qquad ( Equation 4 )$$

That is, the tilt angle VA3 may cover four vertical pitches Vp and one horizontal pitch Hp such that it covers four column pixels and one row pixel.

A width of an aperture of the parallax barrier may be multiples of ¼ times the horizontal pitch Hp of the pixels.

In this case, ¼ is a reciprocal of a coefficient of the vertical pitch Vp of Equation 4.

To reduce moiré patterns and color breakup, the width of the parallax barrier aperture may be 2*¼ times the horizontal pitch Hp of the pixels.

Then, through eight rows of pixels within the parallax barrier aperture, an area substantially equal to that of four pixels may be viewed.

That is, through the eight rows of pixels within the parallax barrier aperture, two green pixels, one red pixel, and one blue pixel may be viewed.

In this case, since center portions of each of the green pixels, red pixels, and blue pixels can be viewed through the aperture, color breakup can be prevented.

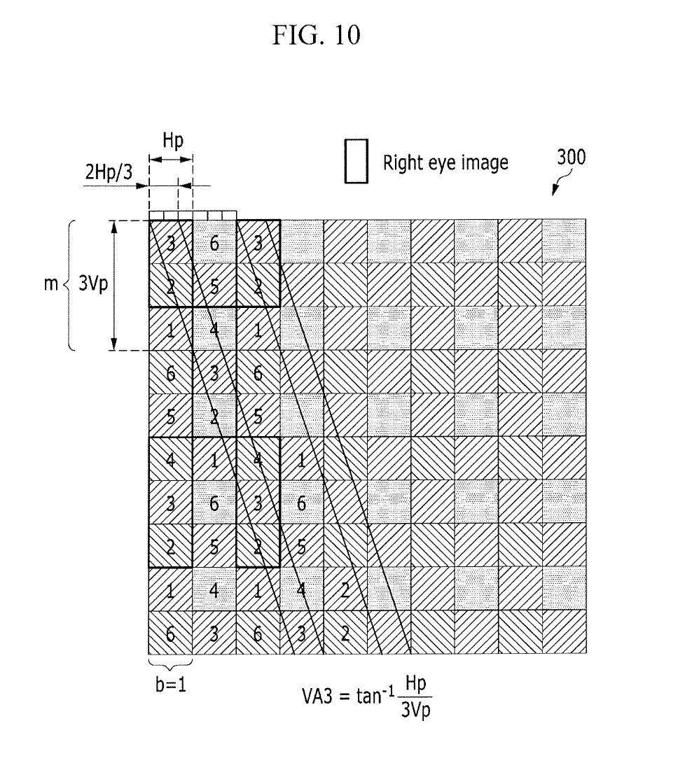

Next, a pixel for displaying a binocular image according to a parallax barrier will now be described with reference to FIG. 10.

FIG. 10 illustrates images displayed in pixels corresponding to an aperture width and tilt angle of a parallax barrier of a stereoscopic image display device according to an exemplary embodiment.

As illustrated therein, the parallax barrier aperture width is smaller than the horizontal pitch Hp of the pixels, and may correspond to 2*⅓ times the horizontal pitch Hp of the pixels.

In addition, a tilt angle of the parallax barrier may satisfy the above Equation 3.

The tilt angle of the parallax barrier may be determined from Equation 1 when m is 3 and b is 1.

When b is 1, if m is excessively large, the binocular image may be vertically shifted based on the arrangement of the red and blue pixels.

Accordingly, if the parallax barrier tilt angle satisfies Equation 1 for b equals 1, then m should be 3.

Light corresponding to a right eye image or a left eye image may be emitted from a unit pixel area corresponding to m×b dots.

In addition, a unit pixel area that emits light corresponding to a left eye image and a unit pixel area that emits light corresponding to a right eye image may be alternately disposed in the display panel.

For example, in FIG. 10, a unit pixel area has a size of 3*1 dots, the unit pixel area that emits light corresponding to the right eye image and the unit pixel area that emits light corresponding to the left eye image are alternately disposed on the display panel.

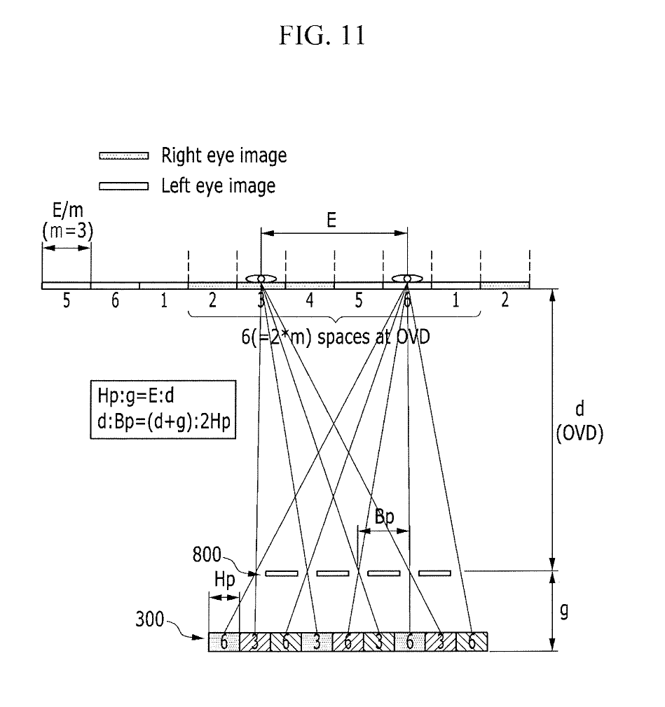

Next, an OVD of a stereoscopic image display device will now be described with reference to FIG. 11.

FIG. 11 illustrates when light of the pixels of a stereoscopic image display device according to an exemplary embodiment pass through the OVD after crossing the parallax barrier.

Referring to FIG. 11, letting the horizontal pitch of the pixels be denoted by Hp, an inter-eye distance of the viewer be denoted by E, and a distance between a parallax barrier and a display panel be denoted by g, the OVD and the barrier pitches may generally satisfy the following Equation 5.

Hp:g=E:d

d:Bp=(d+g):2Hp (Equation 5)

Herein, d represents the OVD, and Bp represents the barrier pitch.

Each pixel may have an observing area of width of E/m at the OVD.

Accordingly, at the OVD, m pixels may form one viewpoint image area within a width of the inter-eye distance E of the viewer.

For example, when pixels 2, 3, and 4 emit light corresponding to the right eye image and pixels 5, 6, and 1 emit light corresponding to the left eye image, three pixels 2, 3, and 4 may form a right-eye viewpoint image area within the width of the inter-eye distance E at the OVD, while three pixels 5, 6, and 1 may form a left-eye viewpoint image area.

Accordingly, at the OVD, a viewpoint image area corresponding to 2m (m=3) pixels may have a width of 2E.

The controller may change which pixels emit light corresponding to a binocular image based on movement of the viewer at the OVD.

The controller may set an observing area having width E/m at the OVD as a unit to be controlled, perform head-tracking, and change which pixels emit light corresponding to the binocular image.

For example, at the OVD, if the left eye of the viewer is determined to be outside of the observing area of the pixels that emit light for the left eye image, the controller may change which pixels emit light for the left eye image.

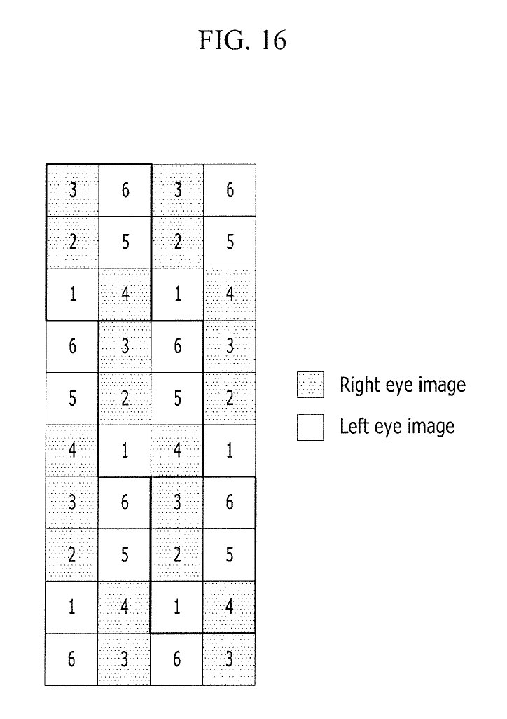

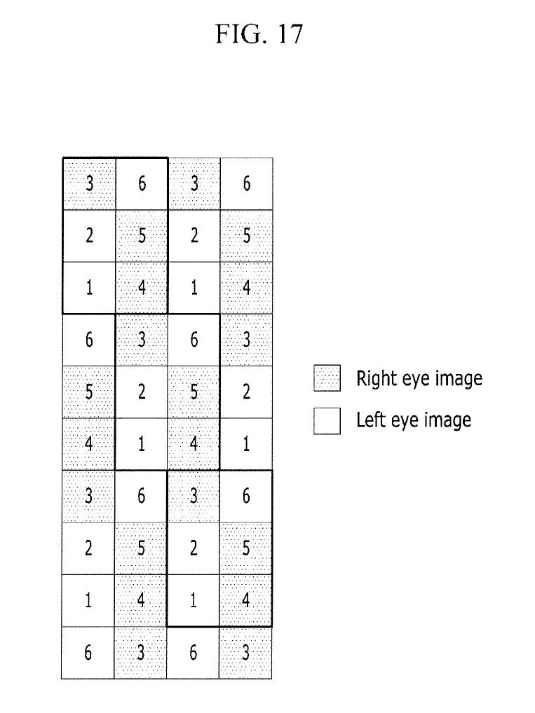

This will be described below with reference to FIGS. 16 and 17.

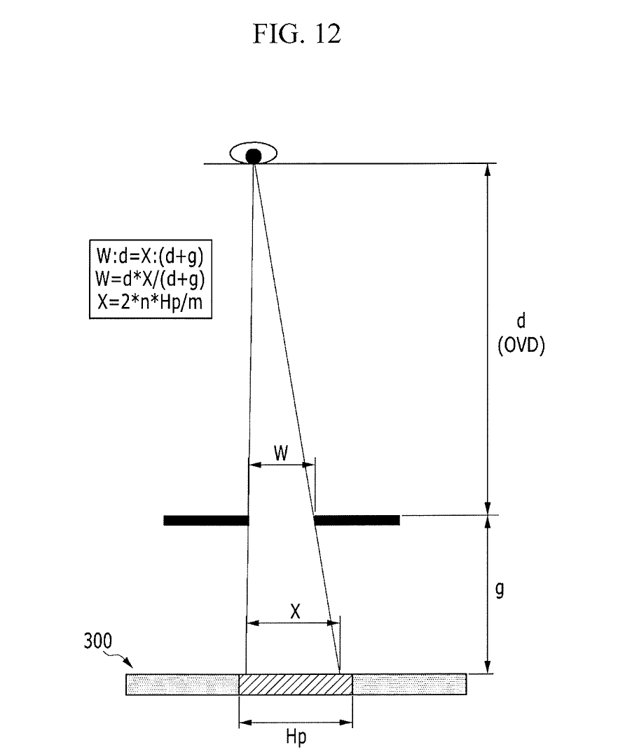

Next, the aperture width of a parallax barrier will now be described with reference to FIG. 12.

FIG. 12 illustrates an aperture width of a parallax barrier of a stereoscopic image display device according to an exemplary embodiment.

As described in FIG. 5, the width of the parallax barrier aperture width may be 2*½ times the horizontal pitch Hp of the pixel.

As described above, to prevent color breakup, the parallax barrier aperture width may be determined using the following Equation 6.

$$X = 2 \times n \times \frac{Hp}{m} \qquad ( Equation 6 )$$

In this case, X is the width of the parallax barrier aperture width, n is a natural number, and m is the coefficient of the vertical pitch Vp.

Since the parallax barrier and the display panel are separated by a predetermined distance, the parallax barrier aperture width satisfies the following Equation 7.

W:d=X:(d+g) (Equation 7)

Herein, W is the parallax barrier aperture width, g is the distance between the parallax barrier and the display panel, and d is the OVD.

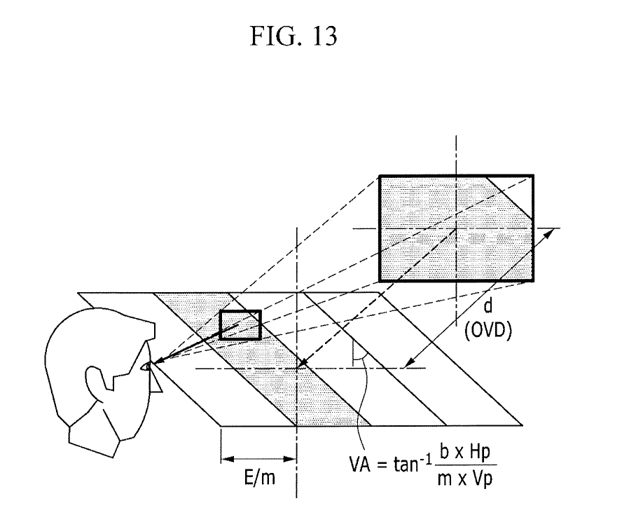

FIG. 13 illustrates an area viewed by a viewer at the OVD through a stereoscopic image display device according to an exemplary embodiment.

As illustrated therein, light corresponding to a binocular image may be viewed by the right eye or left eye of a viewer located at the OVD.

Light from all pixels of the display panel may pass through the corresponding apertures of the parallax barrier to form observing areas having width E/m at the OVD, respectively.

In addition, a slope of each of the observing areas may have the same angle as the tilt angle of the parallax barrier.

A viewer located at the OVD may perceive the right eye image through light that passes through the parallax barrier apertures to the respective observing areas having width E/m at the OVD.

In addition, a viewer located at the OVD may perceive the left eye image through light that passes through the parallax barrier apertures to form the respective observing areas having width E/m at the OVD.

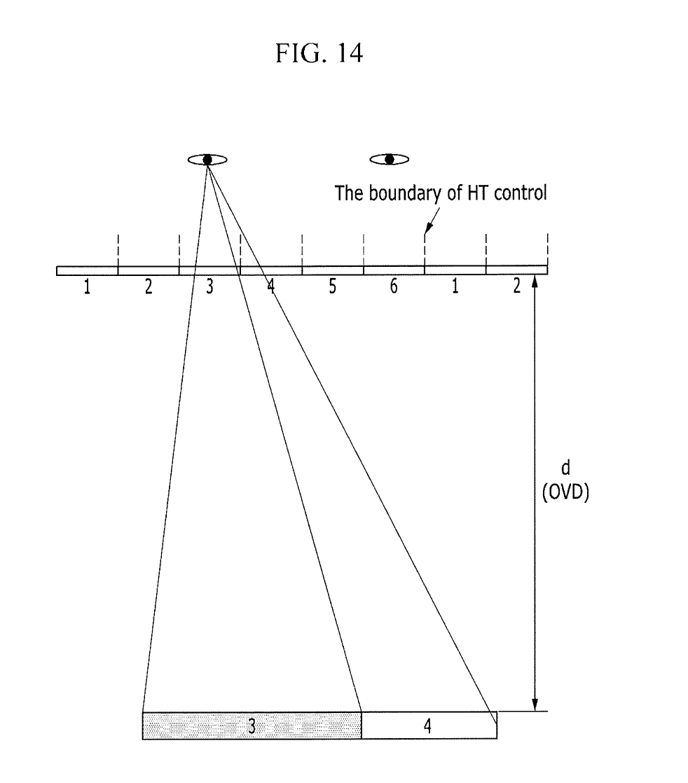

Next, a method of performing head-tracking when a viewer leaves the OVD will be described with reference to FIGS. 14 to 16.

FIGS. 14 to 17 illustrate an example of head-tracking for changing the pixels that emit light corresponding to a binocular image of a stereoscopic image display device according to an exemplary embodiment.

FIG. 14 illustrates a case in which m of the parallax barrier tilt angle corresponds to an odd number (for example, m is 3).

In this case, at the OVD, a boundary of an area of each dot is set as a boundary for head-tracking (HT) control.

As illustrated therein, when a viewer moves away from a stereoscopic image display device, a display screen may be divided by a line that extends between the viewer's right eye and the boundary of the head-tracking control.

For every divided area, head-tracking may be performed based on the area corresponding to each dot.

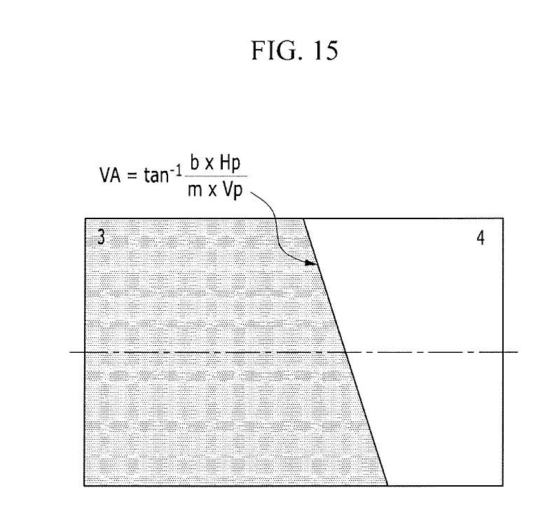

As illustrated in FIG. 15, light of a pixel 3 and light of a pixel 4 viewed by the viewer may be divided by the boundary of the head-tracking control.

In this case, when the light of pixel 3 and the light of pixel 4 are received by a viewer primarily focused on pixel 3, as shown in FIG. 16, the controller may control pixels 2, 3, and 4 to emit light for the right eye image while controlling pixels 5, 6, and 1 to emit light for the left eye image.

In addition, when light of pixel 3 and light of pixel 4 are received by a viewer primarily focused on pixel 4, as shown in FIG. 17, the controller may control pixels 3, 4, and 5 to emit light for the right eye image while controlling pixels 2, 6, and 1 to emit light for the left eye image.

That is, among the pixels viewed by a viewer that are divided by the boundary of the head-tracking control, head-tracking may be performed for the pixels that are most intensively viewed by the viewer.

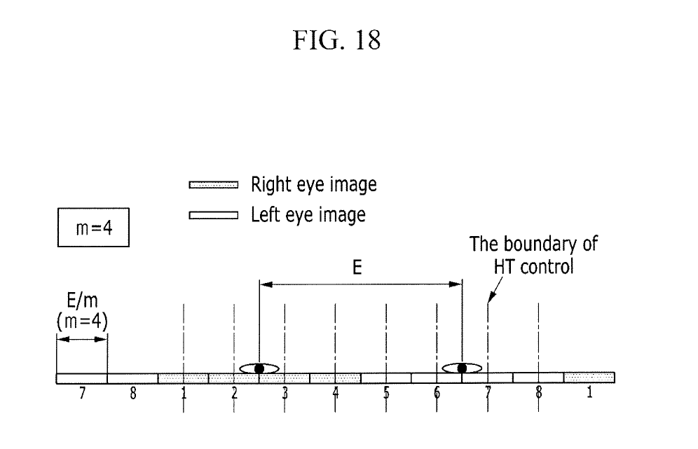

FIG. 18 illustrates a head-tracking boundary for changing pixels that emit light for a binocular image of a stereoscopic image display device according to another exemplary embodiment.

As illustrated therein, when m of the parallax barrier tilt angle corresponds to an even number, such as 4, a center of a boundary of the area for each dot at the OVD is set as a boundary of the head-tracking control.

When a viewer moves away from the stereoscopic image display device, a display screen may be divided by a line that extends between the viewer's right eye and the head-tracking control boundary.

For every divided area, head-tracking may be performed based on two dots that correspond to the center of the area for each dot.

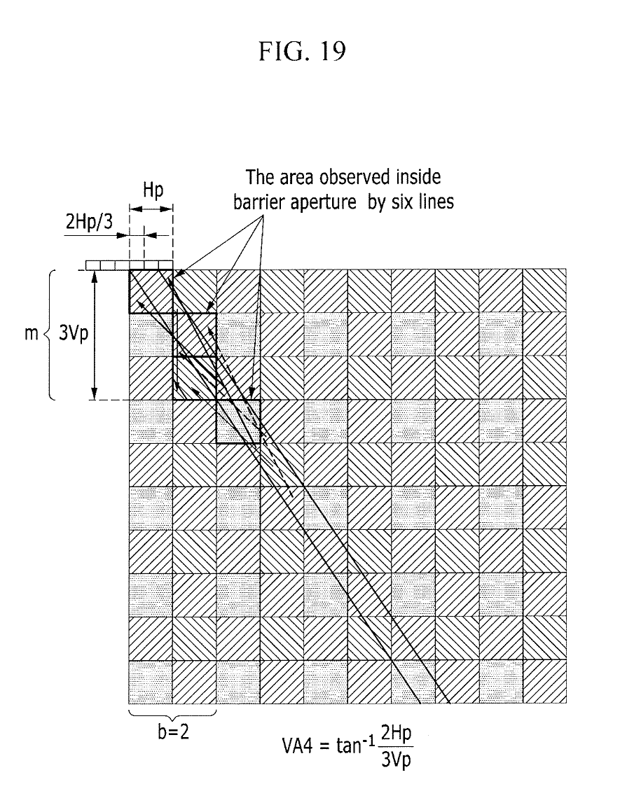

FIG. 19 illustrates pixels that correspond to a parallax barrier aperture and tilt angle in connection with moiré patterns and color breakup of a stereoscopic image display device according to a further exemplary embodiment.

As illustrated therein, a tilt angle VA4 of a parallax barrier disposed at the upper part of a display panel may satisfy the following Equation 8.

$$VA 4 = {tan}^{- 1} \frac{2 Hp}{3 Vp} \qquad ( Equation 8 )$$

That is, the tilt angle VA4 may cover three vertical pitches Vp and two horizontal pitches Hp such that it covers three column pixels and two row pixels.

A width of the parallax barrier aperture may be ⅔ times the horizontal pitch Hp of the pixels.

In this case, ⅔ is the product of a reciprocal of a coefficient of the vertical pitch Vp of the above Equation 8 and a coefficient of the horizontal pitch Hp.

To reduce moiré patterns and color breakup, the width of the parallax barrier aperture may be 2*¼ times the horizontal pitch Hp of the pixels.

Then, through eight rows of pixels within the parallax barrier aperture, an area substantially equal to that of four pixels may be viewed.

That is, through six rows of pixels within the parallax barrier aperture, two green pixels, one red pixel, and one blue pixel may be viewed.

In this case, since center portions of each of the green pixels, red pixels, and blue pixels can be viewed through the aperture, color breakup can be prevented.

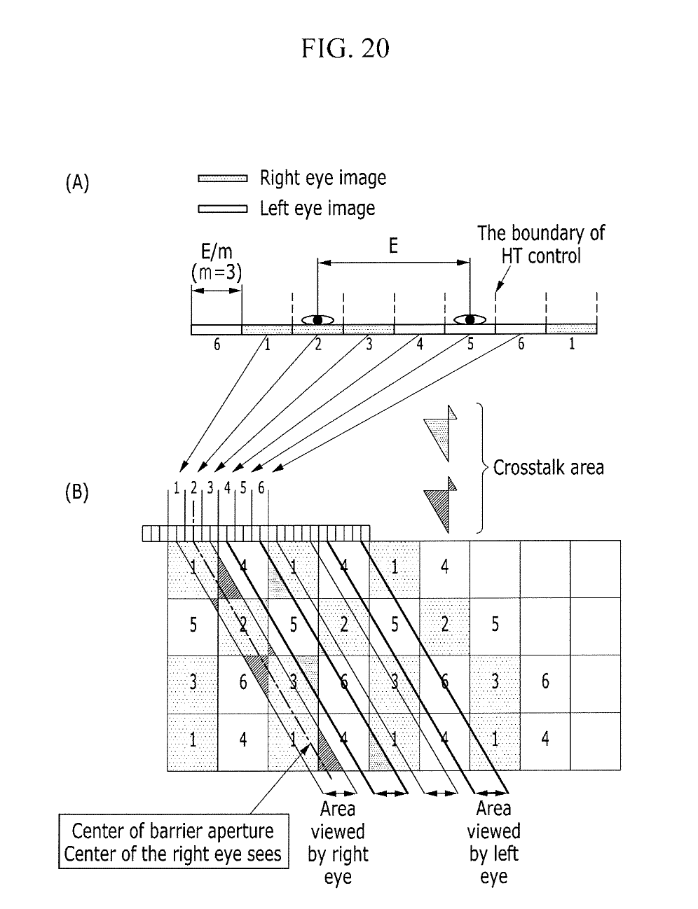

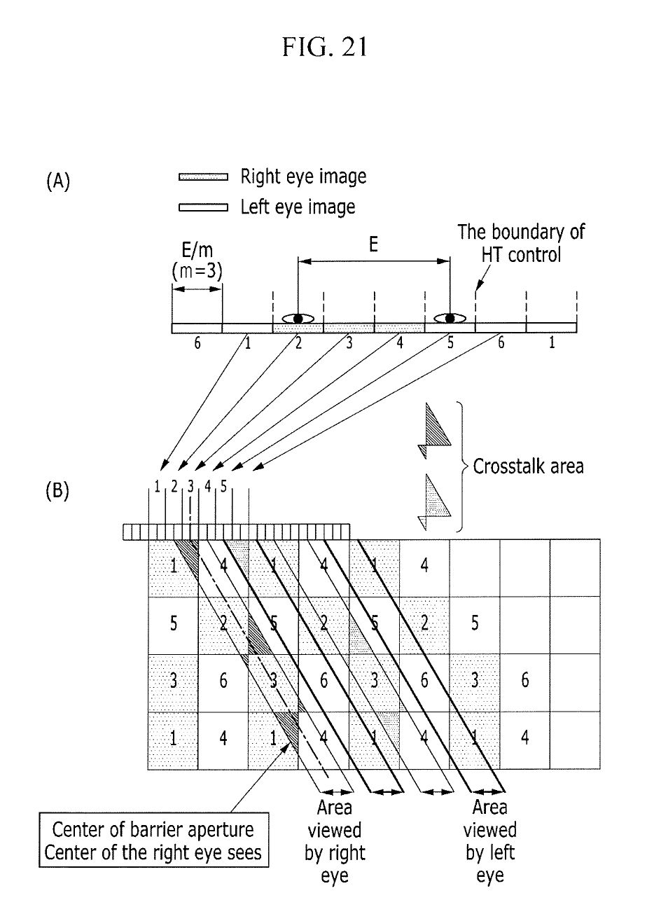

Next, crosstalk and head-tracking in a stereoscopic image display device that includes a parallax barrier having a tilt angle shown in FIG. 19 will now be described with reference to FIGS. 20(A)-(B) and 21(A)-(B).

FIGS. 20(A)-(B) and 21(A)-(B) illustrate head-tracking for changing pixels that emit light for a binocular image of a stereoscopic image display device according to a further exemplary embodiment.

As illustrated in FIG. 20(A), when m of the parallax barrier is 3, a boundary of the observing area may be the boundary of the head-tracking control.

In this case, at an OVD, the viewer's right eye may be located at a center of an observing area 2 while the left eye may be located at a center of an observing area 5.

In addition, as illustrated in FIG. 20(B), pixels 1, 2, and 3 may emit light for the right eye image, while pixels 4, 5, and 6 may emit light for the left eye image.

When the viewer's right eye is located at the center of the observing area 2, an area viewed by the right eye may have a width that corresponds to an aperture width of the parallax barrier.

Since the viewer's right eye is located at the center of observing area 2, an area corresponding to ⅔ times the horizontal pitch may be viewed by the viewer's right eye based on the center of an area that corresponds to the aperture width of the parallax barrier.

Then, based on the center of the area corresponding to the parallax barrier aperture width viewed by the viewer's right eye, pixels 4, 5, and 6 that emit light for the left eye image are located within an area that corresponds to ⅔ times the horizontal pitch, thereby causing crosstalk.

As illustrated in FIG. 21(A), the viewer may move such that at the OVD, the viewer's right eye is located at a center of observing area 3 while the left eye is located at a center of observing area 6.

Then, since the right and left eyes are located outside of the head-tracking control due to the viewers move, the controller may change which pixels emit light corresponding to the binocular image.

Accordingly, as illustrated in FIG. 21(B), the controller may control pixels 2, 3, and 4 to emit light for the right eye image while controlling pixels 1, 5, and 6 to emit light for the left eye image.

When the viewer's right eye is located at the center of observing area 3, an area viewed by the right eye may be have a width that corresponds to the aperture width of the parallax barrier.

Since the viewer's right eye is located at the center of observing area 3, an area corresponding to ⅔ times the horizontal pitch may be viewed by the viewer's right eye based on the center of an area that corresponds to the aperture width of the parallax barrier.

Then, based on the center of the area corresponding to the parallax barrier aperture width viewed by the viewer's right eye, pixels 1, 5, and 6 that emit light for the left eye image are located within an area that corresponds to ⅔ times the horizontal pitch, thereby causing crosstalk.

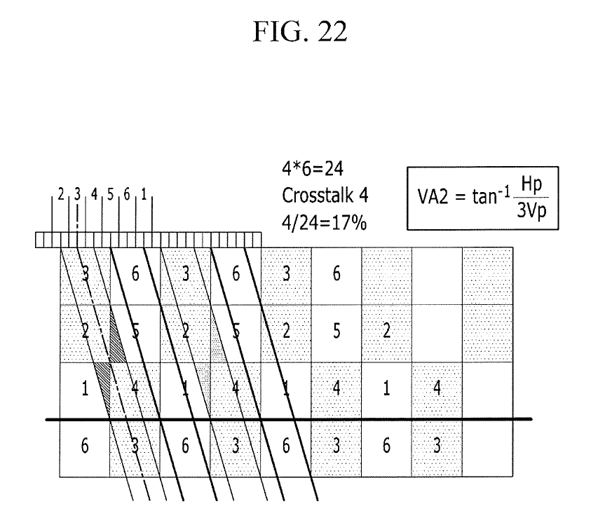

Next, a maximum and a minimum ratio of crosstalk occurrence of a stereoscopic image display device will now be described with reference to FIGS. 22 to 25.

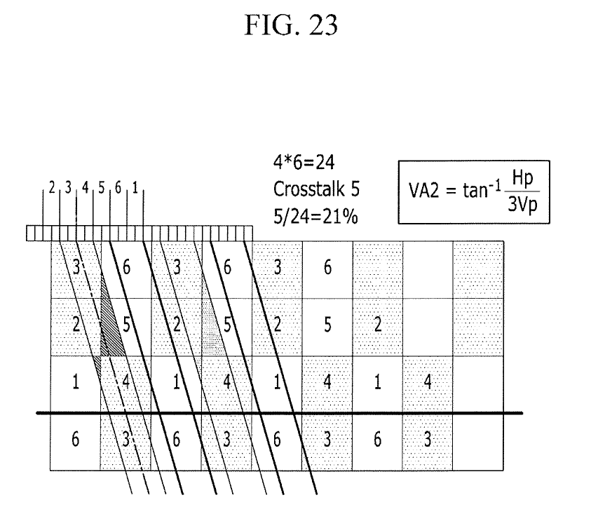

FIGS. 22 and 23 illustrate crosstalk caused by head-tracking of a stereoscopic image display device according to an exemplary embodiment.

As illustrated in FIGS. 22 and 23, along the tilt angle VA2, within three rows, an area having a horizontal width of ⅔ Hp may be an area that is viewed through the parallax barrier.

When one dot is partitioned into 12 areas, a size of the area viewed through the parallax barrier will generally be equivalent to 24 partitioned areas.

Referring to FIG. 22, there may be four areas within the three rows where crosstalk occurs.

Thus, a ratio of crosstalk occurrence is 4/24, corresponding to 17% of the entire areas.

Referring to FIG. 23, after performing head-tracking, there may be five areas within the three rows where crosstalk occurs.

Then, a ratio of crosstalk occurrence is 5/24, corresponding to 21% of the entire areas.

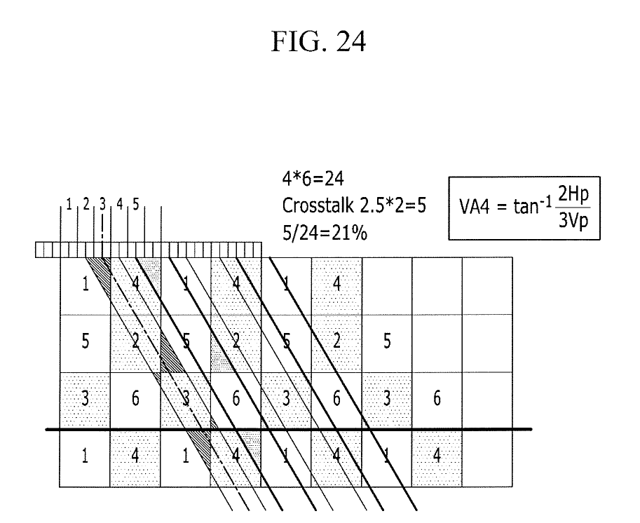

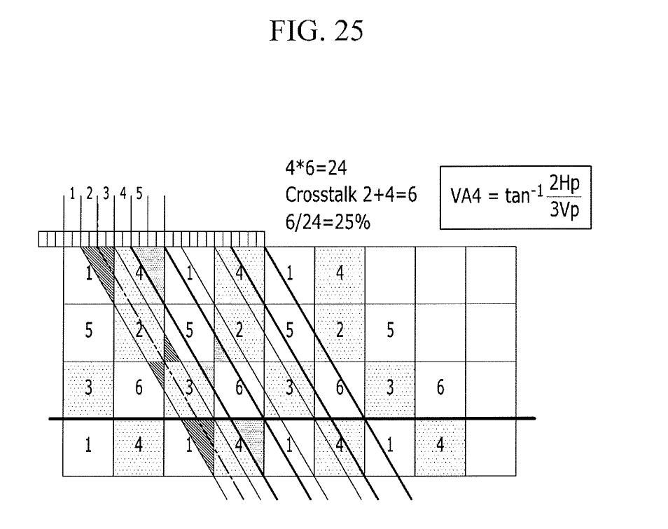

FIGS. 24 and 25 illustrate crosstalk caused by head-tracking of a stereoscopic image display device according to another exemplary embodiment.

As illustrated in FIGS. 24 and 25, an area within three rows having a horizontal width of ⅔ Hp along the tilt angle VA4 may be an area that is viewed through the parallax barrier.

When one dot is partitioned into 12 areas, a size of an area viewed through the parallax barrier will generally be equivalent to 24 partitioned areas.

Referring to FIG. 24, there may be five areas within the three rows where crosstalk occurs.

Then, a ratio of crosstalk occurrence is 5/24, corresponding to 21% of the entire area.

Referring to FIG. 25, after performing head-tracking, there may be six areas within the three rows where crosstalk occurs.

Then, a ratio of crosstalk occurrence is 6/24, corresponding to 25% of the entire areas.

As described above in FIGS. 23 to 25, the crosstalk occurrence ratios caused by a stereoscopic image display device according to various exemplary embodiments are low, thereby preventing crosstalk occurrence in an autostereoscopic image display device.

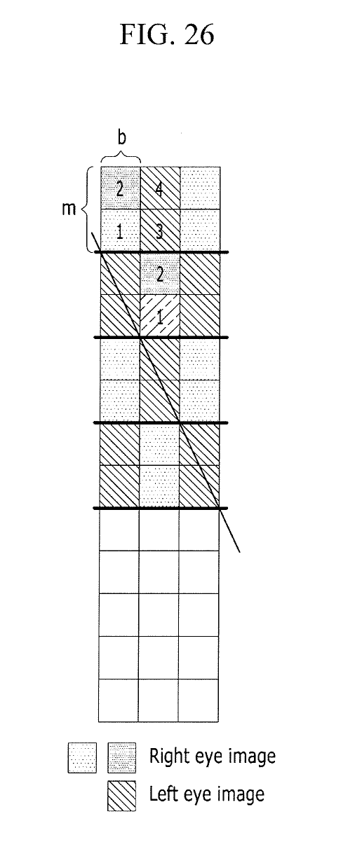

Next, the tilt angles of a parallax barrier and the pixels that respectively emit light for the left eye image or the right eye image according to the tilt angles will be described with reference to FIGS. 26 to 35.

FIGS. 26 to 35 illustrate tilt angles of a parallax barrier according to a stereoscopic image display device according to various exemplary embodiments and the pixels that emit light for the images displayed according to the tilt angles.

As illustrated in FIG. 26, for a parallax barrier having a tilt angle where m is 2 and b is 1 in Equation 1, the controller controls pixels 1 and 2 to emit light for the right eye image while controlling pixels 3 and 4 to emit light for the left eye image.

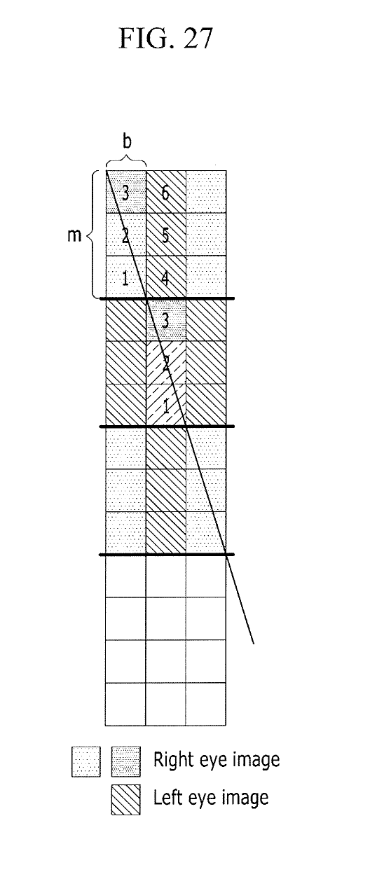

As shown in FIG. 27, for a parallax barrier having a tilt angle where m is 3 and b is 1 in Equation 1, the controller controls pixels 1, 2, and 3 to emit light for the right eye image while controlling pixels 4, 5, and 6 to emit light for the left eye image.

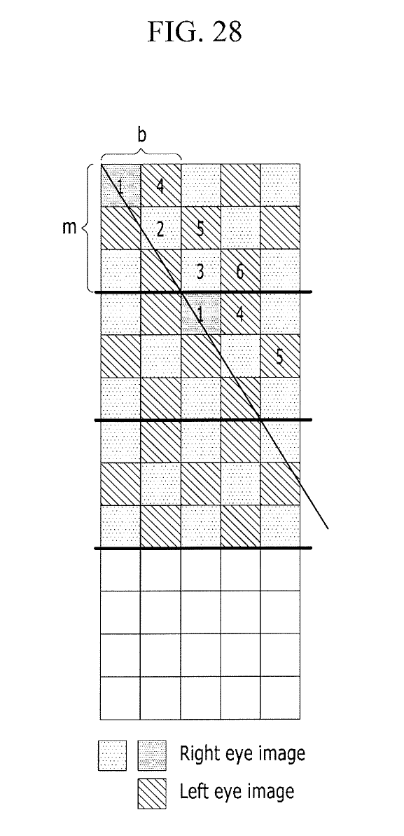

As shown in FIG. 28, for a parallax barrier having a tilt angle where m is 3 and b is 2 in Equation 1, the controller controls pixels 1, 2, and 3 to emit light for the right eye image while controlling pixels 4, 5, and 6 to emit light for the left eye image.

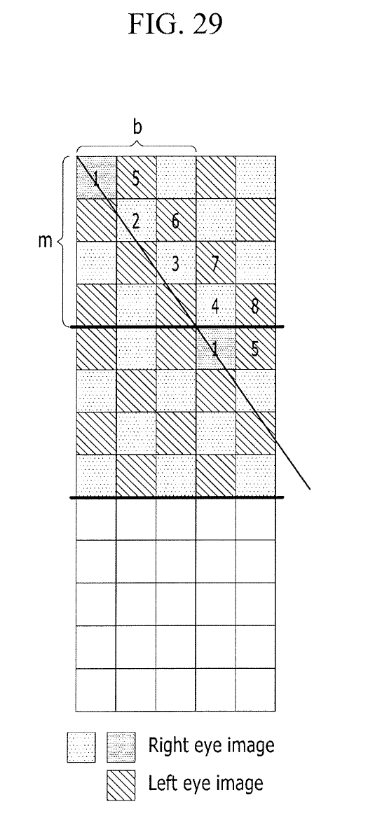

As shown in FIG. 29, for a parallax barrier having a tilt angle where m is 4 and b is 3 in Equation 1, the controller controls pixels 1 to 4 to emit light for the right eye image while controlling pixels 5 to 8 to emit light for the left eye image.

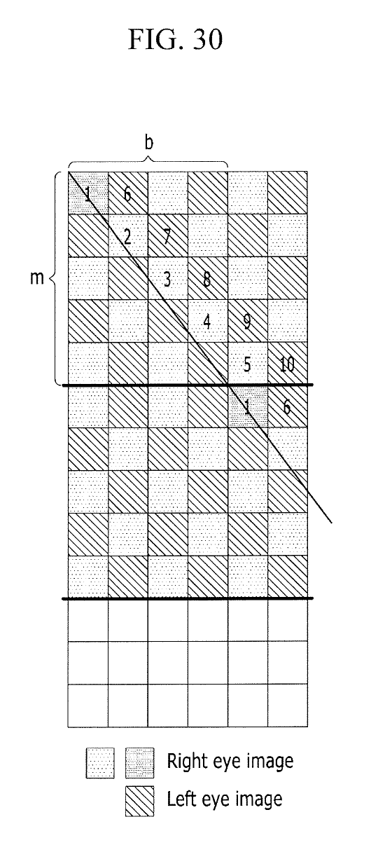

As shown in FIG. 30, for a parallax barrier having a tilt angle where m is 5 and b is 4 in Equation 1, the controller controls pixels 1 to 5 to emit light for the right eye image while controlling pixels 6 to 10 to emit light for the left eye image.

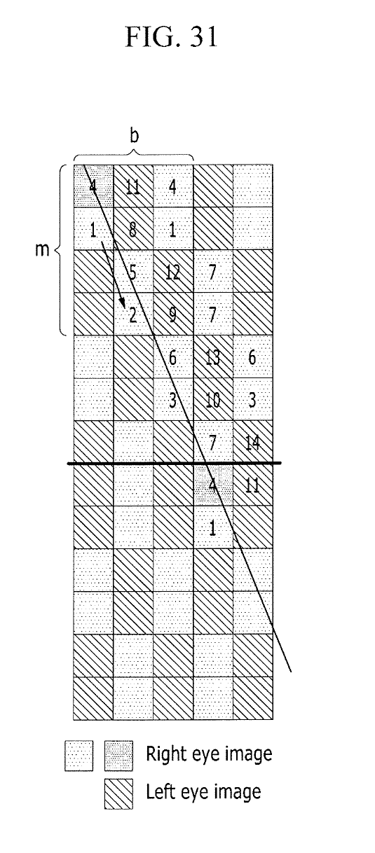

As shown in FIG. 31, for a parallax barrier having a tilt angle where m is 7 and b is 3 in Equation 1, the controller controls pixels 1 to 7 to emit light for the right eye image while controlling pixels 8 to 14 to emit light for the left eye image.

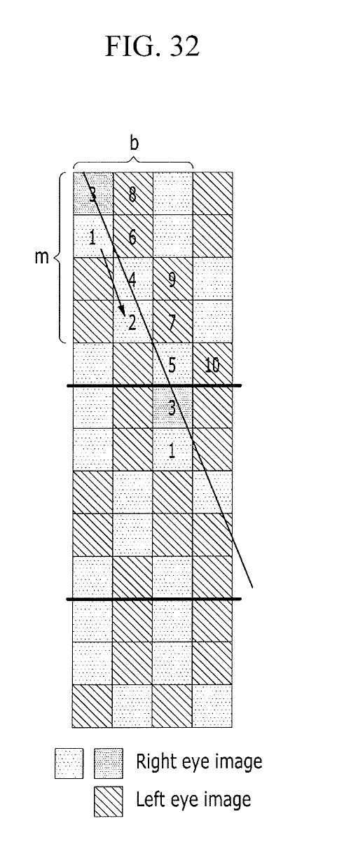

As shown in FIG. 32, for a parallax barrier having a tilt angle where m is 5 and b is 2 in Equation 1, the controller controls pixels 1 to 5 to emit light for the right eye image while controlling pixels 6 to 10 to emit light for the left eye image.

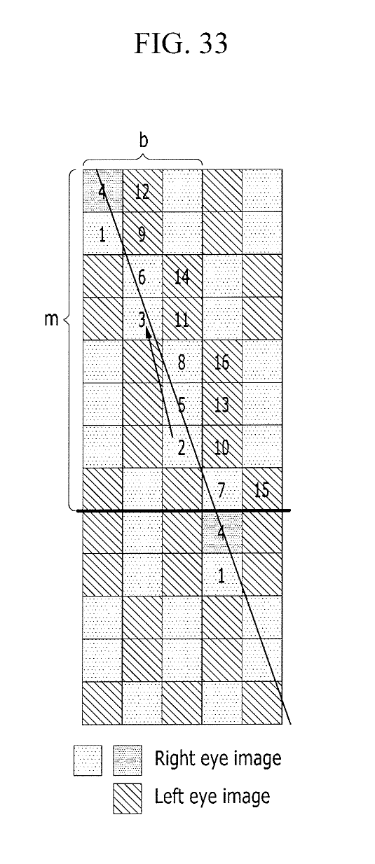

As shown in FIG. 33, for a parallax barrier having a tilt angle where m is 8 and b is 3 in Equation 1, the controller controls pixels 1 to 8 to emit light for to the right eye image while controlling pixels 9 to 16 to emit light for the left eye image.

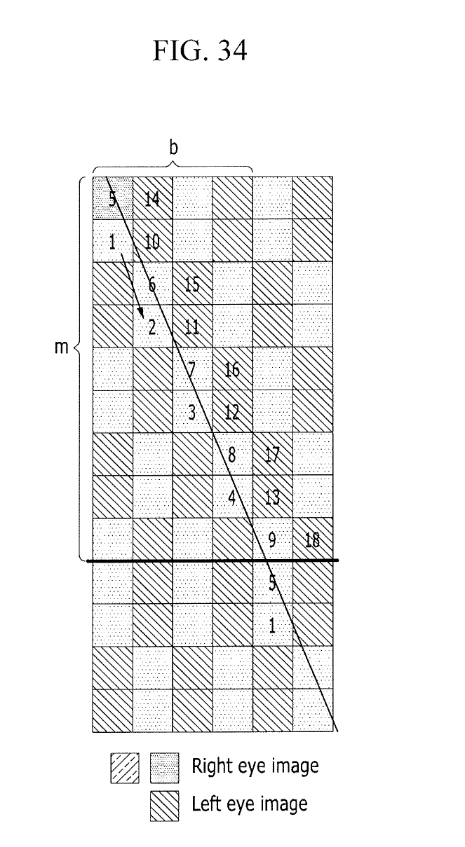

As shown in FIG. 34, for a parallax barrier having a tilt angle where m is 9 and b is 4 in Equation 1, the controller controls pixels 1 to 9 to emit light for the right eye image while controlling pixels 10 to 18 to emit light for the left eye image.

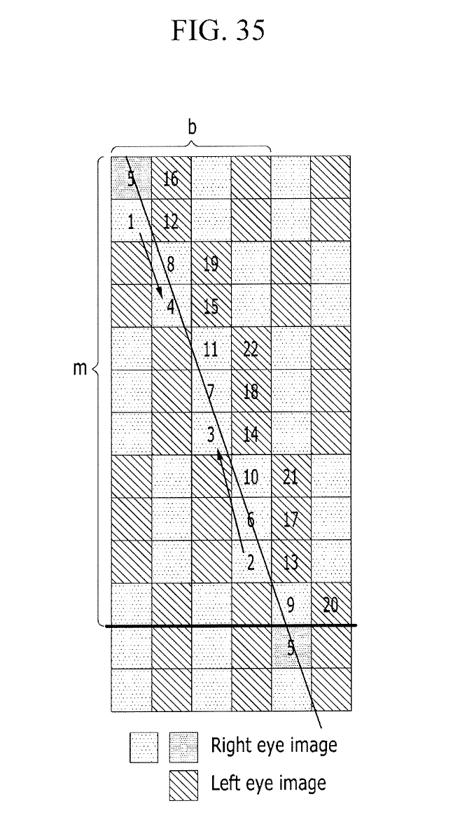

As shown in FIG. 35, for a parallax barrier having a tilt angle where m is 11 and b is 4 in Equation 1, the controller controls pixels 1 to 11 to emit light for the right eye image while controlling pixels 12 to 22 to emit light for to the left eye image.

In the case of a stereoscopic image display device of FIGS. 26 to 35 as described above, the controller may control the pixels such that light for different viewpoint images is emitted in a row direction for every pixel.

In addition, as illustrated in FIGS. 26 and 27, for a stereoscopic image display device that includes a parallax barrier having a tilt angle where b is 1 in Equation 1, the controller may control the pixels such that light for different viewpoint images is emitted in a column direction for every m pixels.

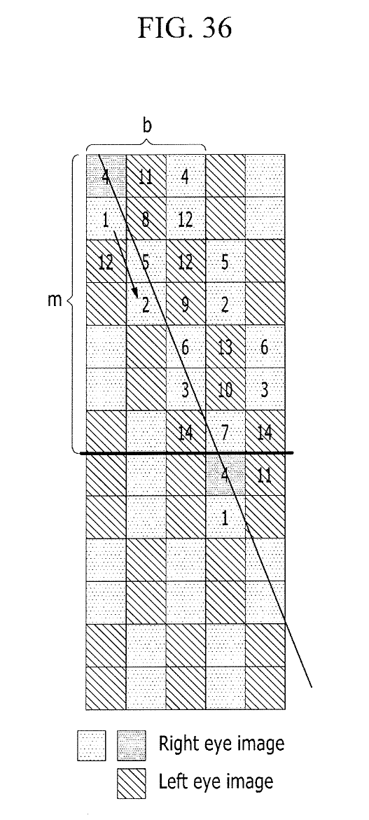

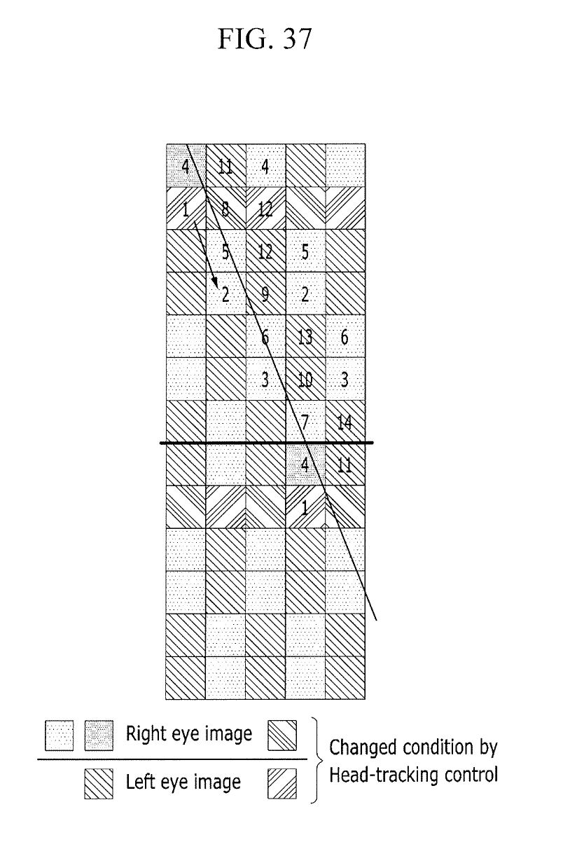

Next, a head-tracking control of an image display device according to an exemplary embodiment of FIG. 31 will be described with reference to FIGS. 36 and 37.

FIGS. 36 and 37 illustrate head-tracking for changing pixels that emit light for a binocular image of a stereoscopic image display device according to a exemplary embodiment of FIG. 31.

As shown in FIG. 36, for a parallax barrier having a tilt angle where m is 7 and b is 3 in Equation 1, the controller controls pixels 1 to 7 to emit light for the right eye image while controlling pixels 8 to 14 to emit light for the left eye image.

In this case, when a viewer's position at the OVD changes, the sensor detects the changed viewer's position, and the controller may change which pixels emit light for the binocular image based on the boundary of the head-tracking control.

Accordingly, as shown in FIG. 37, the controller controls pixels 2 to 8 to emit light for the right eye image while controlling pixels 1 and 9 to 14 to emit light for the left eye image.

Embodiments of the present disclosure may be implemented as a code in a non-transitory computer readable medium in which a program is recorded.

The non-transitory computer readable medium may include all types of recording apparatuses in which data readable by a computer system may be stored.

An example of a non-transitory computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, etc.

In addition, the computer may include a controller of a terminal.

Therefore, the above detailed description is not to be interpreted as being restrictive, but is to be considered as being illustrative.

The scope of the present disclosure is to be determined by reasonable interpretation of the claims, and all alterations within equivalences of the present disclosure fall within the scope of the present disclosure. Those skilled in the art will understand that the present disclosure may be modified in various different ways without departing from the spirit or essential features of the present disclosure.

What is claimed is:

1. A stereoscopic image display device comprising:
a display panel that includes a plurality of pixels arranged in a matrix form; and
a viewpoint separating unit configured to divide an image displayed by the display panel into images corresponding to k viewpoints,
wherein the viewpoint separating unit includes a plurality of viewpoint separating units that are tilted at a tilt angle VA with respect to a column direction of the pixels that satisfies the following equation:
$$VA = {tan}^{- 1} \frac{b \times Hp}{m \times Vp} ,$$
wherein Hp denotes a pitch in a row direction of the pixels, Vp denotes a pitch in the column direction of the pixels, and m and b are natural numbers, and a width of a display panel area viewed at an optimal viewing distance (OVD) by each of the viewpoint separating units satisfies
$$\frac{2 n}{m} \times Hp ,$$
wherein n is a natural number.

2. The stereoscopic image display device of claim 1, wherein the viewpoint separating units include a parallax barrier.

3. The stereoscopic image display device of claim 1, wherein
$$\frac{2 n}{m}$$
is less than 1.

4. The stereoscopic image display device of claim 3, wherein the plurality of pixels emit light that corresponds to different viewpoint images in the row direction for every pixel.

5. The stereoscopic image display device of claim 1, wherein, when b is 1, the plurality of pixels emit light corresponding to different viewpoint images in the column direction for every m pixels.

6. The stereoscopic image display device of claim 5, wherein m is less than 4.

7. The stereoscopic image display device of claim 2, wherein the viewpoint separating unit includes a plurality of apertures and a plurality of light blocking portions, and satisfies the following equations:
Hp:g=E:d
d:Bp=(d+g):2Hp,
wherein d denotes the OVD, Bp denotes an interval between the apertures, E denotes an interval between both eyes of a viewer, and g denotes a distance between the viewpoint separating unit and the display panel.

8. The stereoscopic image display device of claim 7, wherein the following equation is satisfied:
W:d=X:(d+g),
wherein X denotes the width of the display panel area viewed at the OVD through each of the viewpoint separating units and W denotes an aperture width.

9. The stereoscopic image display device of claim 1, further comprising:
a sensor configured to detect positions of both eyes of a viewer; and
a controller configured to perform head-tracking to change which pixels are displayed in images corresponding to the k viewpoints.

10. The stereoscopic image display device of claim 9, wherein the controller sets observing areas having a width of E/m at the OVD as head tracking control units, and performs head-tracking.

11. The stereoscopic image display device of claim 10, wherein the controller sets a boundary of the head tracking control units as a boundary for head-tracking control if m is an odd number.

12. The stereoscopic image display device of claim 10, wherein the controller sets a center of the head tracking control units as a boundary for head-tracking control if m is an even number.

13. A stereoscopic image display device comprising:
a display panel that includes a plurality of pixels arranged in a matrix form; and
a viewpoint separating unit configured to divide an image displayed by the display panel into images corresponding to k viewpoints,
wherein the viewpoint separating unit includes a plurality of viewpoint separating units that include a parallax barrier,
wherein the viewpoint separating unit includes a plurality of apertures and a plurality of light blocking portions, and satisfies the following equations:
Hp:g=E:d
d:Bp=(d+g):2Hp
wherein d denotes the OVD, Bp denotes an interval between the apertures, E denotes an interval between both eyes of a viewer, and g denotes a distance between the viewpoint separating unit and the display panel.

14. The stereoscopic image display device of claim 13, wherein the viewpoint separating units are tilted at a tilt angle VA with respect to a column direction of the pixels that satisfies the following equation:
$$VA = {tan}^{- 1} \frac{b \times Hp}{m \times Vp} ,$$
wherein Hp denotes a pitch in a row direction of the pixels, Vp denotes a pitch in the column direction of the pixels, and m and b are natural numbers, and
a width of a display panel area viewed at an optimal viewing distance (OVD) by each of the viewpoint separating units satisfies
$$\frac{2 n}{m} \times Hp ,$$
wherein n is a natural number.

15. The stereoscopic image display device of claim 13, further comprising:
a sensor configured to detect positions of both eyes of a viewer; and
a controller configured to perform head-tracking to change which pixels are displayed in images corresponding to the k viewpoints,
wherein the controller sets observing areas having a width of E/m at the OVD as head tracking control units, and performs head-tracking.

16. The stereoscopic image display device of claim 13, wherein the following equation is satisfied:
W:d=X:(d+g),
wherein X denotes the width of the display panel area viewed at the OVD through each of the viewpoint separating units and W denotes an aperture width.

17. A stereoscopic image display device comprising:
a display panel that includes a plurality of pixels arranged in a matrix form;
a viewpoint separating unit configured to divide an image displayed by the display panel into images corresponding to k viewpoints, wherein the viewpoint separating unit includes a plurality of viewpoint separating units;
a sensor configured to detect positions of both eyes of a viewer; and
a controller configured to perform head-tracking to change which pixels are displayed in images corresponding to the k viewpoints,
wherein the controller sets observing areas having a width of E/m at an optimal viewing distance (OVD) as head tracking control units, and performs head-tracking, wherein E denotes an interval between both eyes of a viewer, and m is a natural number that is a coefficient of a vertical pitch of the pixels.

18. The stereoscopic image display device of claim 17, wherein the viewpoint separating units include a parallax barrier,
wherein the viewpoint separating unit includes a plurality of apertures and a plurality of light blocking portions, and satisfies the following equations:
Hp:g=E:d
d:Bp=(d+g):2Hp,
W:d=X:(d+g),
wherein d denotes the OVD, Bp denotes an interval between the apertures, E denotes an interval between both eyes of a viewer, g denotes a distance between the viewpoint separating unit and the display panel, X denotes the width of the display panel area viewed at the OVD through each of the viewpoint separating units and W denotes an aperture width.

19. The stereoscopic image display device of claim 17, wherein the viewpoint separating units are tilted at a tilt angle VA with respect to a column direction of the pixels that satisfies the following equation:
$$VA = {tan}^{- 1} \frac{b \times Hp}{m \times Vp} ,$$
wherein Hp denotes a pitch in a row direction of the pixels, Vp denotes a pitch in the column direction of the pixels, and m and b are natural numbers, and
a width of a display panel area viewed at an optimal viewing distance (OVD) by
each of the viewpoint separating units satisfies
$$\frac{2 n}{m} \times Hp ,$$
wherein n is a natural number.
